(19) United States
(12) Patent Application Publication
(10) Pub. No.: US 2020/0212578 A1
(43) Pub. Date: Jul. 2, 2020

(54) FILTER ANTENNA

(71) Applicant: AAC Technologies Pte. Ltd., Singapore city (SG)

(72) Inventor: Mao Liu, Shenzhen (CN)

(21) Appl. No.: 16/706,793

(22) Filed: Dec. 8, 2019

(30) Foreign Application Priority Data
Dec. 31, 2018 (CN) 201822279023.7

(51) Int. Cl. H01Q 9/04; H01Q 1/48

(52) U.S. Cl. CPC H01Q 9/0414; H01Q 9/045; H01Q 1/48

(57) ABSTRACT

A filter antenna is provided, including: a circuit substrate layer; an antenna ground layer attached to a bottom surface of the circuit substrate layer, a first antenna layer embedded in the circuit substrate layer, and a second antenna layer attached to a top surface of the circuit substrate layer. The antenna ground layer is provided with a microstrip line, the second antenna layer and the first antenna layer are spaced apart from each other and form a coupling, and the first antenna layer is fed with power by the microstrip line. Compared with the related art, the filter antenna provided by the present invention has a thin overall thickness, and has a filtering function and good reliability, which can satisfy requirements of the indoor 5G communication base station.

### TECHNICAL FIELD

The present invention relates to the field of antenna technologies, and in particular, to a filter antenna.

### BACKGROUND

A fifth generation (5G) of communication technology is aimed at building an ecosystem of information and communication technologies and is one of the most popular topics in a current industry. Unlike previous 2G, 3G and 4G, the 5G is not just an upgrade of mobile communication technology, but it is also a driving platform for a future digital world and an infrastructure for development of the Internet of Things, which will truly create a new era of full connectivity.

However, with the development of the 5G technology, it is difficult for existing millimeter wave antennas to meet requirements of indoor base stations.

Therefore, it is necessary to provide a new filter antenna to solve the above problems.

### BRIEF DESCRIPTION OF DRAWINGS

Many aspects of exemplary embodiment can be better understood with reference to following drawings. Components in the drawings are not necessarily drawn to scale, the emphasis instead being placed upon clearly illustrating principles of the present invention. Moreover, in the drawings, like reference numerals designate corresponding parts throughout the several views.

FIG. 1 is a perspective structural schematic diagram of a filter antenna according to the present invention;

FIG. 2 is a partially exploded perspective structural schematic diagram of a filter antenna of according to the present invention;

FIG. 3 is a cross-sectional diagram taken along line A-A in FIG. 1;

FIG. 4 is an enlarged diagram of a portion B in FIG. 3;

FIG. 5 illustrates a reflection coefficient curve of a filter antenna according to the present invention; and

FIG. 6 illustrates an efficiency curve of a filter antenna according to the present invention.

### DESCRIPTION OF EMBODIMENTS

The present invention will be further illustrated with reference to the accompanying drawings and the embodiments.

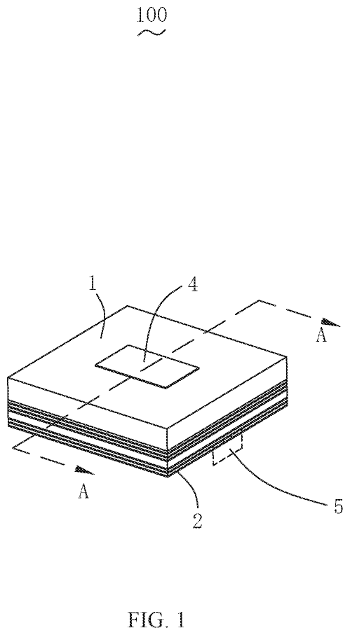

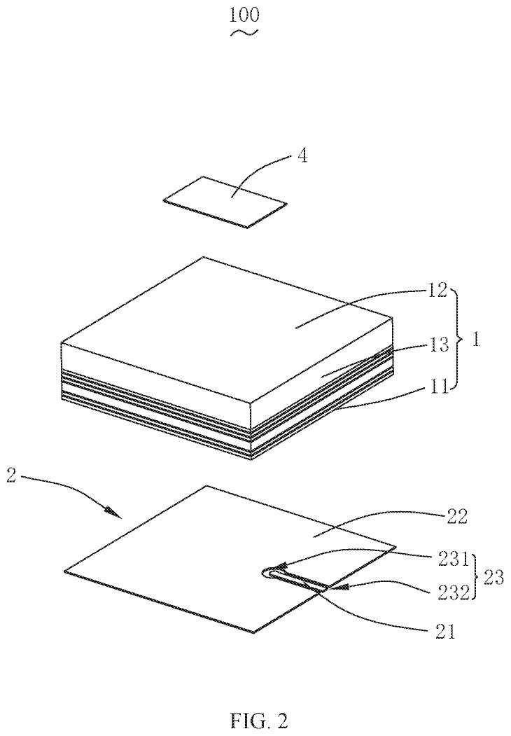

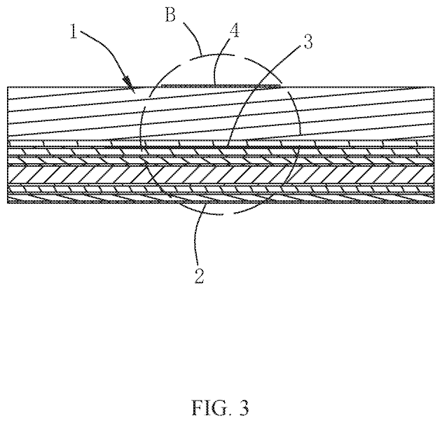

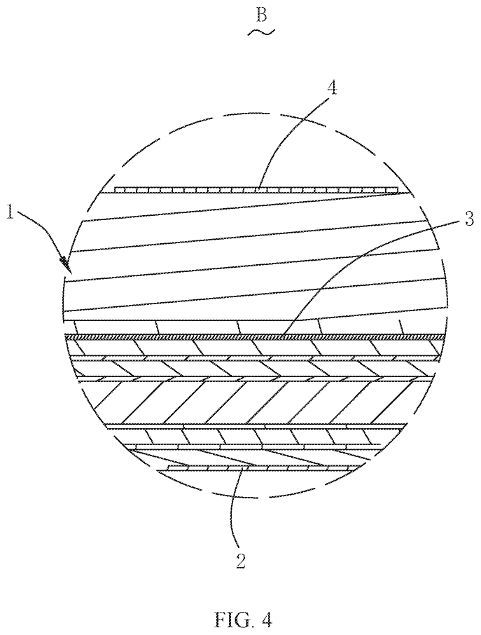

Referring to FIGS. 1-4, the present invention provides a filter antenna 100, and the filter antenna 100 includes a circuit substrate layer 1, an antenna ground layer 2, a first antenna layer 3, a second antenna layer 4, a feeding port 5, and a feeding probe (not shown). The circuit substrate layer 1, the antenna ground layer 2, the first antenna layer 3, and the second antenna layer 4 are stacked, such that the filter antenna has a thickness of 0.8 to 1.2 mm and an overall thickness is relatively thin.

The circuit substrate layer 1 includes a bottom surface 11, a top surface 12 opposite to the bottom surface 11, and a side surface 13 connecting the bottom surface 11 and the top surface 12.

The antenna ground layer 2 is attached to the bottom surface 11 of the antenna substrate layer 1. The antenna ground layer 2 is provided with a microstrip line 21.

The first antenna layer 3 is embedded in the antenna substrate layer 1. In one embodiment, the first antenna layer 3 is a patch-type radiator for achieving power feeding. The first antenna layer 3 is fed with power by the microstrip line 21.

The second antenna layer 4 is attached to the top surface 12 of the circuit substrate layer 1. In one embodiment, the second antenna layer 4 is a patch-type radiator.

In the present invention, the antenna ground layer 2 includes a body 22 attached to the bottom surface 11 of the circuit substrate layer 1 and a semi-closed feeding slot 23 formed in the body 22. The microstrip line 21 is received in the semi-closed slot 23 and extends along the semi-closed slot 23. The microstrip line 21 is spaced apart from the body 22.

The semi-closed slot 23 includes a closed end 231 and an open end 232. The feeding port 5 is disposed at the open end 232, and the microstrip line 23 is fed with power through the feeding port 5.

The second antenna layer 4 and the first antenna layer 3 are spaced apart from each other and form a coupling; the first antenna layer 3 is fed with power through the microstrip line 21. The feeding probe connects the first antenna layer 3 with an end of the microstrip line 21 corresponding to the closed end 231.

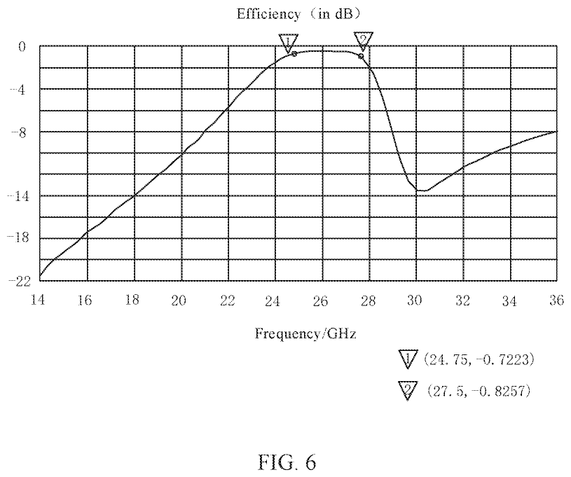

In the present invention, the second antenna layer 4 and the first antenna layer 3 are coupled to function as a filter coupling sheet. Therefore, the filter antenna 100 itself has a filtering function. If the feeding port 5 of the filter antenna 100 is regarded as a first port and a far field radiation area is regarded as a second port, then a radiation efficiency of the filter antenna 100 is equivalent to S21 (a transmission coefficient) of one filter. In combination with FIG. 6, the filter antenna 100 of the present invention has a pass band only at a required frequency band, and both the low and high frequencies are stop bands.

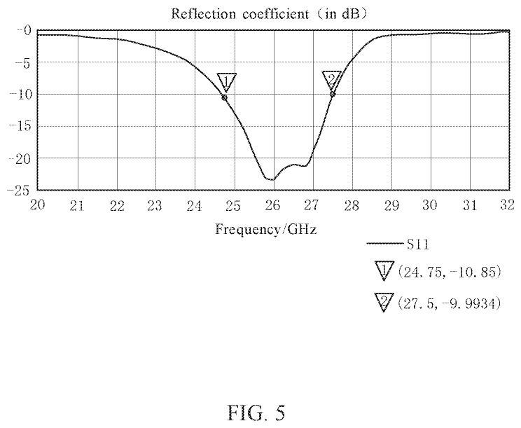

Referring to FIGS. 5-6 in combination, with the above structure, the filter antenna 100 of the present invention has a bandwidth of 24.7˜27.5 GHz and a relative bandwidth of 10.5%, so that it has a filtering function and good reliability. For increasingly complex spectrum resources, clutter filtering begins at the filter antenna 100 itself, which protects a back-end radio frequency circuit, thereby improving the reliability.

Compared with the related art, the filter antenna provided by the present invention adopts a stacked structure, has a relatively thin overall thickness and spaces the first antenna layer apart from the second antenna layer to form a coupling, such that the first antenna layer is fed with power through the feeding port of the antenna ground layer, and the filter antenna realizes filtering of the clutter, thereby protecting the back-end radio frequency circuit and satisfying requirements of the indoor 5G communication base station.

What have been described above are only embodiments of the present invention, and it should be noted herein that those skilled in the art can make improvements without departing from the inventive concept of the present invention, but these are all within the scope of the present invention.

What is claimed is:

1. A filter antenna, comprising:
a circuit substrate layer;
an antenna ground layer attached to a bottom surface of the circuit substrate layer;
a first antenna layer embedded in the circuit substrate layer; and
a second antenna layer attached to a top surface of the circuit substrate layer,
wherein the antenna ground layer is provided with a microstrip line, the second antenna layer and the first antenna layer are spaced apart from each other and form a coupling, and the first antenna layer is fed with power by the microstrip line.

2. The filter antenna as described in claim 1, wherein the first antenna layer and the second antenna layer are each a patch-type radiator.

3. The filter antenna as described in claim 1, wherein the antenna ground layer comprises a body attached to the bottom surface of the circuit substrate layer and a semi-closed feeding slot formed in the body, the microstrip line is received in the semi-closed slot and extends along the semi-closed slot, and the microstrip line is spaced apart from the body.

4. The filter antenna as described in claim 3, wherein the semi-closed slot comprises a closed end and an open end, the filter antenna further comprises a feeding port disposed at the open end, and the microstrip line is fed with power through the feeding port.

5. The filter antenna as described in claim 4, further comprising a feeding probe, wherein the feeding probe connects the first antenna layer to an end of the microstrip line corresponding to the closed end.

6. The filter antenna as described in claim 1, wherein the filter antenna has a bandwidth in a range of 24.75 GHz to 27.5 GHz and a relative bandwidth in a range of 10.5%.

7. The filter antenna as described in claim 1, wherein the filter antenna has a thickness in a range of 0.8 mm to 1.2 mm.
